(19) United States
(12) Patent Application Publication
(10) Pub. No.: US 2007/0259984 A1
(43) Pub. Date: Nov. 8, 2007

(54) Microporous coating based on polyurethane polyurea

(75) Inventors: Sebastian Dorr, Dusseldorf (DE); Thorsten Rische, Unna (DE); Thomas Feller, Solingen (DE); Michael Heckes, Krefeld (DE); Holger Casselmann, Odenthal (DE); Thomas Michaelis, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/796,388

(22) Filed: Apr. 27, 2007

(30) Foreign Application Priority Data
May 4, 2006 (DE) 102006020745.9

(51) Int. Cl. C08G 18/00

(52) U.S. Cl. 521/172

(57) ABSTRACT

The invention relates to novel microporous coatings based on polyurethane polyurea, and to a process for the production of microporous coatings, in which a composition comprising an aqueous, anionically hydrophilised polyurethane dispersion (I) and a cationic coagulant (II) containing a cationically hydrophilised polyurethane polyurea dispersion is foamed and dried.

### CROSS-REFERENCE TO RELATED APPLICATION

This application claims priority under 35 U.S.C. § 119 (a-d) to German application DE 10 2006 020745.9, filed May 4, 2006.

### FIELD OF THE INVENTION

The invention relates to novel microporous coatings and to a process for the production of microporous coatings.

### BACKGROUND OF THE INVENTION

In the field of textile coating, polyurethanes in their various application forms—solution, high solid, aqueous dispersions—traditionally play an important role. For many years, especially in the field of coatings, the trend has increasingly been moving away from solventbased systems towards high solids and, in particular, aqueous systems because of the ecological advantages thereof.

The situation with polyurethane artificial leathers is still somewhat different. According to the current state of the art, these microporous coatings are still being produced mostly by the so-called bath coagulation process.

In the process of bath coagulation, which is the preferred process used today, textiles are coated or impregnated with polyurethanes dissolved in organic solvents (e.g. dimethylformamide). The coagulation takes place immediately thereafter by immersion in a water bath. The resulting coatings are distinguished by their softness and good water vapour permeability. Because of the specific properties of the organic solvent (dissolving power, miscibility with water, etc.), the process is tied to the use of this solvent.

Disadvantages of this process are in particular the complex measures that are necessary for the safe handling, the working-up and the recycling of the very large amounts of solvent.

In alternative methods such as evaporation coagulation, which is based on the use of a volatile solvent and a less volatile non-solvent for the binder, the solvent preferentially escapes first with gentle heating, so that the binder coagulates as a result of the constantly increasing amount of non-solvent; in addition to the use of large amounts of solvent, which are likewise necessary, disadvantages are the enormous technical outlay that is required and the fact that optimisation possibilities are very limited by the process parameters.

Salt, acid or electrolyte coagulation, which are also used, are carried out by immersion of the coated substrate or, as in the case of gloves, of the mould first immersed in the dispersion, in a concentrated salt solution or in water with added acid, or the like, the binder coagulating as a result of the high electrolyte content. Disadvantages of this process are the complicated technical procedure and, above all, the large amount of loaded waste water that forms.

The prepolymer method, according to which a substrate coated with isocyanate prepolymer is immersed in water and then a polyurea of porous structure is obtained with CO2 cleavage, proves to be a disadvantageous process inter alia because of the very high reactivity of the formulations and the associated short processing times.

Coagulation by raising the temperature, which is possible for binders that have been rendered heat-sensitive and are not post-crosslinkable, often leads to unacceptable coating results.

DE-A 19 856 412 describes a process for aqueous coagulation based on post-crosslinkable aqueous polyurethane dispersions which proceeds successfully without or with only a small content of organic solvent and without the use of salt, acid or other electrolyte baths and which, as a whole, constitutes a simple process. The described process is suitable in particular for the coating of non-microporous compact films of small layer thickness.

DE-A 10 300 478 describes a process based predominantly on the aqueous post-crosslinkable polyurethane dispersions of DE-A 19 856 412, according to which these polyurethane dispersions, after being foamed, are applied to a textile substrate and are coagulated thermally thereon at temperatures of from 100C to 110C by means of special coagulants and are suitable for the production of compact coatings which are used, for example, as printed artificial suede in the automotive sector, on furniture or in the clothing sector.

According to the current state of the art based on ecologically unacceptable aqueous polyurethane polyurea dispersions (PUR dispersions), the production of microporous coatings having high layer thicknesses by aqueous coagulation has not yet been solved satisfactorily and is therefore the object of the present invention.

### SUMMARY OF THE INVENTION

It has now been found, surprisingly, that it is possible to obtain spreadable pastes having advantageous properties by using special anionically hydrophilised PUR dispersions (I) in combination with cationically hydrophilised polyurethane polyurea dispersions as cationic coagulants (II).

It has additionally been found that microporous coatings having high layer thicknesses can be produced by a novel process comprising the following process steps:
A. production of a spreadable coating composition (1) comprising an aqueous, anionically hydrophilised polyurethane polyurea dispersion (1) and a cationically hydrophilised polyurethane polyurea dispersion as cationic coagulant (II),
B. foaming of (1) with the simultaneous, at least partial coagulation of the foam at low temperature,
C. application of the foamed and at least partially coagulated composition (1) to a textile carrier,
D. drying and optionally
E. fixing of the foam matrix by a further drying step at elevated temperature.

The present invention also provides a process for the preparation of the spreadable coating composition (1), characterised in that the coating composition (1) comprises components selected from the group
I.) aqueous, anionically hydrophilised polyurethane dispersion whose content of —COO⁻ or —SO3⁻ or PO₃²⁻ groups is from 0.1 to 15 milliequivalents per 100 g of solid resin,
II.) cationically hydrophilised polyurethane polyurea dispersion as cationic coagulant,
III.) foaming agent
IV.) crosslinker and optionally
V.) thickener
   and, prior to step B.), these components are mixed together homogeneously in any desired sequence according to known mixing processes.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The aqueous, anionically hydrophilised polyurethane dispersions (I) present in the compositions fundamental to the invention are obtainable as follows:

A) isocyanate-functional prepolymers are prepared from
A1) organic polyisocyanates
A2) polymeric polyols having number-average molecular weights of from 400 to 8000 g/mol., preferably from 400 to 6000 g/mol. and particularly preferably from 600 to 3000 g/mol., and OH functionalities of from 1.5 to 6, preferably from 1.8 to 3, particularly preferably from 1.9 to 2.1, and
A3) optionally hydroxy-functional compounds having molecular weights of from 32 to 400 g/mol. and
A4) optionally isocyanate-reactive, anionic or potentially anionic and/or optionally non-ionic hydrophilising agents,

B) the free NCO groups thereof are then reacted wholly or partially
B1) optionally with amino-functional compounds having molecular weights of from 32 to 400 g/mol. and/or
B2) with isocyanate-reactive, preferably aminofunctional, anionic or potentially anionic hydrophilising agents,
   to provide at least partial chain extension, and the prepolymers so obtained are dispersed in water before, during or after step B), potentially ionic groups that may be present being converted into the ionic form by partial or complete reaction with a neutralising agent.

In order to achieve anionic hydrophilisation there must be used in A4) and/or B2) hydrophilising agents that contain at least one group reactive towards NCO groups, such as amino, hydroxy or thiol groups, and that additionally contain —COO⁻ or —SO₃⁻ or —PO₃²⁻ as anionic groups or the wholly or partially protonated acid forms thereof as potentially anionic groups.

Preferred aqueous, anionic polyurethane dispersions (1) have a low degree of hydrophilic anionic groups, preferably from 0.1 to 15 milliequivalents per 100 g of solid resin.

In order to achieve good stability towards sedimentation, the number-average particle size of the special polyurethane dispersions is preferably less than 750 nm, particularly preferably less than 500 nm and very particularly preferably less than 400 nm, determined by means of laser correlation spectroscopy.

The ratio of NCO groups in the compounds of component A1) to NCO-reactive groups such as amino, hydroxy or thiol groups in the compounds of components A2) to A4) during the preparation of the NCO-functional prepolymer is from 1.05 to 3.5, preferably from 1.2 to 3.0, particularly preferably from 1.3 to 2.5.

The amino-functional compounds in step B) are used in such an amount that the equivalent ratio of isocyanatereactive amino groups in these compounds to the free isocyanate groups in the prepolymer is from 40 to 150%, preferably from 50 to 125%, particularly preferably from 60 to 120%.

Suitable polyisocyanates of component A1) are the aromatic, araliphatic, aliphatic or cycloaliphatic polyisocyanates having a NCO functionality of 2 that are known to the person skilled in the art.

Examples of such suitable polyisocyanates are 1,4butylene diisocyanate, 1,6-hexamethylene diisocyanate (HDI), isophorone diisocyanate (IPDI), 2,2,4- and/or 2,4,4-trimethylhexamethylene diisocyanate, the isomers of bis(4,4′-isocyanatocyclohexyl)methane or mixtures thereof of any desired isomer content, 1,4-cyclohexylene diisocyanate, 1,4-phenylene diisocyanate, 2,4- and/or 2,6toluylene diisocyanate, 1,5-naphthylene diisocyanate, 2,2′- and/or 2,4′- and/or 4,4′-diphenylmethane diisocyanate, 1,3- and/or 1,4-bis-(2-isocyanato-prop-2yl)-benzene (TMXDI), 1,3-bis(isocyanatomethyl)benzene (XDI) and alkyl 2,6-diisocyanato-hexanoates (lysine diisocyanates) having C1-C8-alkyl groups.

In addition to the polyisocyanates mentioned above, it is possible for modified diisocyanates having a uretdione, isocyanurate, urethane, allophanate, biuret, iminooxadiazinedione and/or oxadiazinetrione structure, as well as non-modified polyisocyanate having more than 2 NCO groups per molecule, for example 4-isocyanatomethyl1,8-octane diisocyanate (nonane triisocyanate) or triphenylmethane-4,4′,4″-triisocyanate, also to be used concomitantly.

The polyisocyanates or polyisocyanate mixtures of the above-mentioned type preferably contain only aliphatically and/or cycloaliphatically bonded isocyanate groups and have a mean NCO functionality of the mixture of from 2 to 4, preferably from 2 to 2.6 and particularly preferably from 2 to 2.4.

Particular preference is given to the use in A1) of 1,6hexamethylene diisocyanate, isophorone diisocyanate, the isomers of bis(4,4′-isocyanatocyclohexyl)methane and mixtures thereof.

In A2), polymeric polyols having a number-average molecular weight Mn of from 400 to 8000 g/mol., preferably from 400 to 6000 g/mol. and particularly preferably from 600 to 3000 g/mol. are used. They have a OH functionality of preferably from 1.5 to 6, particularly preferably from 1.8 to 3, very particularly preferably from 1.9 to 2.1.

Such polymeric polyols are the polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols known per se in polyurethane coating technology. They can be used in A2) individually or in any desired mixtures with one another.

Such polyester polyols are the polycondensation products, known per se, of diols and optionally triols and tetraols and di- as well as optionally tri- and tetra-carboxylic acids or hydroxycarboxylic acids or lactones. Instead of the free polycarboxylic acids, it is also possible to use in the preparation of the polyesters the corresponding polycarboxylic acid anhydrides or corresponding polycarboxylic acid esters of lower alcohols.

Examples of suitable diols are ethylene glycol, butylene glycol, diethylene glycol, triethylene glycol, polyalkylene glycols such as polyethylene glycol, also 1,2-propanediol, 1,3-propanediol, butanediol(1,3), butanediol(1,4), hexanediol(1,6) and isomers, neopentyl glycol or hydroxypivalic acid neopentyl glycol ester, preference being given to hexanediol(1,6) and isomers, neopentyl glycol and hydroxypivalic acid neopentyl glycol ester. In addition, polyols such as trimethylolpropane, glycerol, erythritol, pentaerythritol, trimethylolbenzene or trishydroxyethyl isocyanurate can also be used.

As dicarboxylic acids there can be used phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2methylsuccinic acid, 3,3-diethylglutaric acid and/or 2,2-dimethylsuccinic acid. The corresponding anhydrides can also be used as the acid source.

Provided the mean functionality of the polyol to be esterified is >2, monocarboxylic acids, such as benzoic acid and hexanecarboxylic acid, can additionally be used concomitantly.

Preferred acids are aliphatic or aromatic acids of the above-mentioned type. Adipic acid, isophthalic acid and optionally trimellitic acid are particularly preferred.

Hydroxycarboxylic acids, which can be used concomitantly as reactants in the preparation of a polyester polyol having terminal hydroxyl groups, are, for example, hydroxycaproic acid, hydroxybutyric acid, hydroxydecanoic acid, hydroxystearic acid and the like. Suitable lactones are caprolactones, butyrolactone and homologues thereof. Caprolactone is preferred.

It is also possible to use in A2) hydroxyl-group containing polycarbonates, preferably polycarbonate diols, having number-average molecular weights Mn of from 400 to 8000 g/mol., preferably from 600 to 3000 g/mol. They are obtainable by reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8octanediol, neopentyl glycol, 1,4-bishydroxymethyl cyclohexane, 2-methyl-1,3-propanediol, 2,2,4trimethylpentanediol-1,3, dipropylene glycol, polypropylene glycols, dibutylene glycol, polybutylene glycols, bisphenol A and lactone-modified diols of the above-mentioned type.

The polycarbonate diol preferably contains from 40 to 100 wt. % hexanediol, preferably 1,6-hexanediol, and/or hexanediol derivatives. Such hexanediol derivatives are based on hexanediol and contain ester or ether groups in addition to terminal OH groups. Such derivatives are obtainable by reaction of hexanediol with excess caprolactone or by etherification of hexanediol with itself to give di- or tri-hexylene glycol.

Instead of or in addition to pure polycarbonate diols, polyether polycarbonate diols can also be used in A2).

The hydroxyl-group-containing polycarbonates are preferably linear in structure. Polyether polyols can likewise be used in A2).

There are suitable, for example, the polytetramethylene glycol polyethers known per se in polyurethane chemistry, as are obtainable by polymerisation of tetrahydrofuran by means of cationic ring opening.

Suitable polyether polyols are also the addition products, known per se, of styrene oxide, ethylene oxide, propylene oxide, butylene oxides and/or epichlorohydrin with di- or poly-functional starter molecules. Polyether polyols based on the at least partial addition of ethylene oxide to di- or poly-functional starter molecules can also be used as component A4) (non-ionic hydrophilising agents).

As suitable starter molecules there can be used all compounds known according to the prior art, such as, for example, water, butyl diglycol, glycerol, diethylene glycol, trimethylolpropane, propylene glycol, sorbitol, ethylenediamine, triethanolamine, 1,4-butanediol. Preferred starter molecules are water, ethylene glycol, propylene glycol, 1,4-butanediol, diethylene glycol and butyl diglycol.

Particularly preferred forms of the polyurethane dispersions (I) contain as component A2) a mixture of polycarbonate polyols and polytetramethylene glycol polyols, the amount of polycarbonate polyols in the mixture being from 20 to 80 wt. % and the amount of polytetramethylene glycol polyols being from 80 to 20 wt. %. Preference is given to an amount of from 30 to 75 wt. % polytetramethylene glycol polyols and an amount of from 25 to 70 wt. % polycarbonate polyols. Particular preference is given to an amount of from 35 to 70 wt. % polytetramethylene glycol polyols and an amount of from 30 to 65 wt. % polycarbonate polyols, in each case with the proviso that the sum of the percentages by weight of the polycarbonate and polytetramethylene glycol polyols is 100% and the proportion of the sum of the polycarbonate and polytetramethylene glycol polyether polyols in component A2) is at least 50 wt. %, preferably 60 wt. % and particularly preferably at least 70 wt. %.

The compounds of component A3) have molecular weights of from 62 to 400 g/mol.

In A3) it is possible to use polyols of the mentioned molecular weight range having up to 20 carbon atoms, such as ethylene glycol, diethylene glycol, triethylene glycol, 1,2-propanediol, 1,3-propanediol, 1,4-butanediol, 1,3-butylene glycol, cyclohexanediol, 1,4cyclohexanedimethanol, 1,6-hexanediol, neopentyl glycol, hydroquinone dihydroxyethyl ether, bisphenol A (2,2-bis(4hydroxphenyl)propane), hydrogenated bisphenol A (2,2bis(4-hydroxycyclohexyl)propane), trimethylolpropane, glycerol, pentaerythritol, and any desired mixtures thereof with one another.

Also suitable are ester diols of the mentioned molecular weight range, such as -hydroxybutyl-hydroxycaproic acid ester, -hydroxyhexyl-hydroxybutyric acid ester, adipic acid (-hydroxyethyl) ester or terephthalic acid bis(hydroxyethyl) ester.

It is also possible to use in A3) monofunctional, isocyanate-reactive, hydroxyl-group-containing compounds. Examples of such monofunctional compounds are ethanol, nbutanol, ethylene glycol monobutyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol.

Preferred compounds of component A3) are 1,6-hexanediol, 1,4-butanediol, neopentyl glycol and trimethylolpropane.

Anionically or potentially anionically hydrophilising compounds of component A4) are understood as being all compounds that contain at least one isocyanate-reactive group such as a hydroxyl group and at least one functionality such as, for example, —COO⁻M⁺, —SO₃⁻M⁺, PO(O⁻M⁺)₂ where M⁺ is, for example, a metal cation, H⁺, NH₄⁺, NHR₃⁺, where R can in each case be a C₁-C₁₂-alkyl radical, a C₅-C₆-cycloalkyl radical and/or a C₂-C₄-hydroxyalkyl radical, which, on interaction with aqueous media, enters into a pH-dependent dissociation equilibrium and in that manner can be negatively or neutrally charged. Suitable anionically or potentially anionically hydrophilising compounds are mono- and dihydroxycarboxylic acids, mono- and di-hydroxysulfonic acids and also mono- and di-hydroxy-phosphonic acids and their salts. Examples of such anionic or potentially anionic hydrophilising agents are dimethylolpropionic acid, dimethylolbutyric acid, hydroxypivalic acid, malic acid, citric acid, glycolic acid, lactic acid and the propoxylated adduct of 2-butenediol and NaHSO₃, as is described in DE-A 2 446 440, pages 5-9, formulae I-III. Preferred anionic or potentially anionic hydrophilising agents of component A4) are those of the above-mentioned type that have carboxylate or carboxylic acid groups and/or sulfonate groups.

Particularly preferred anionic or potentially anionic hydrophilising agents A4) are those that contain carboxylate or carboxylic acid groups as ionic or potentially ionic groups, such as dimethylolpropionic acid, dimethylolbutyric acid and hydroxypivalic acid and the salts thereof.

Suitable non-ionically hydrophilising compounds of component A4) are, for example, polyoxyalkylene ethers containing at least one hydroxy or amino group, preferably at least one hydroxy group.

Examples are the monohydroxy-functional polyalkylene oxide polyether alcohols having in the statistical mean from 5 to 70, preferably from 7 to 55, ethylene oxide units per molecule, as are obtainable in a manner known per se by alkoxylation of suitable starter molecules (e.g. in Ullmanns Encyclopädie der technischen Chemie, 4th Edition, Volume 19, Verlag Chemie, Weinheim p. 3138).

They are either pure polyethylene oxide ethers or mixed polyalkylene oxide ethers containing at least 30 mol. %, preferably at least 40 mol. %, ethylene oxide units, based on all alkylene oxide units present.

Particularly preferred non-ionic compounds are monofunctional mixed polyalkylene oxide polyethers containing from 40 to 100 mol. % ethylene oxide units and from 0 to 60 mol. % propylene oxide units.

Suitable starter molecules for such non-ionic hydrophilising agents are saturated monoalcohols such as methanol, ethanol, n-propanol, isopropanol, n-butanol, isobutanol, sec.-butanol, the isomers of pentanol, hexanol, octanol and nonanol, n-decanol, n-dodecanol, ntetradecanol, n-hexadecanol, n-octadecanol, cyclohexanol, the isomers of methylcyclohexanol, or hydroxymethylcyclohexane, 3-ethyl-3-hydroxymethyloxetan or tetrahydrofurfuryl alcohol, diethylene glycol monoalkyl ethers, such as, for example, diethylene glycol monobutyl ether, unsaturated alcohols such as allyl alcohol, 1,1-dimethylallyl alcohol or oleic alcohol, aromatic alcohols such as phenol, the isomers of cresol or methoxyphenol, araliphatic alcohols such as benzyl alcohol, anis alcohol or cinnamic alcohol, secondary monoamines such as dimethylamine, diethylamine, dipropylamine, diisopropylamine, dibutylamine, bis-(2ethylhexyl)-amine, N-methyl- and N-ethyl-cyclohexylamine or dicyclohexylamine, as well as heterocyclic secondary amines such as morpholine, pyrrolidine, piperidine or 1Hpyrazole. Preferred starter molecules are saturated monoalcohols of the above-mentioned type. Particular preference is given to the use of diethylene glycol monobutyl ether or n-butanol as starter molecules.

Suitable alkylene oxides for the alkoxylation reaction are in particular ethylene oxide and propylene oxide, which can be used in the alkoxylation reaction in any desired sequence or alternatively as a mixture.

There can be used as component B1) di- or poly-amines such as 1,2-ethylenediamine, 1,2- and 1,3-diaminopropane, 1,4-diaminobutane, 1,6-diaminohexane, isophoronediamine, isomeric mixture of 2,2,4- and 2,4,4-trimethyl hexamethylenediamine, 2-methylpentamethylenediamine, diethylenetriamine, triaminononane, 1,3- and 1,4-xylylenediamine, α,α,α,′α′-tetramethyl-1,3- and -1,4xylylenediamine and 4,4-diaminocyclohexylmethane and/or dimethylethylenediamine. The use of hydrazine or hydrazides such as adipic acid dihydrazide is also possible. Preference is given to isophoronediamine, 1,2ethylenediamine, 1,4-diaminobutane, hydrazine and diethylenetriamine.

It is possible to use as component B 1) also compounds that contain, in addition to a primary amino group, also secondary amino groups or, in addition to an amino group (primary or secondary), also OH groups. Examples thereof are primary/-secondary amines, such as diethanolamine, 3amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine.

It is also possible to use as component B1) monofunctional, isocyanate-reactive amine compounds, such as, for example, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amideamines of diprimary amines and monocarboxylic acids, monoketimes of diprimary amines, primary/tertiary amines, such as N,N-dimethylaminopropylamine.

Preferred compounds of component B1) are hydrazine, 1,2ethylenediamine, 1,4-diaminobutane and isophoronediamine.

Anionically or potentially anionically hydrophilising compounds of component B2) are understood as being all compounds that contain at least one isocyanate-reactive group, preferably an amino group, and at least one functionality such as, for example, —COO⁻M⁺, —SO₃⁻M⁻, PO(O⁻M⁺)₂ where M⁺ is, for example, a metal cation, H⁺, NH₄⁺, NHR₃⁺, where R can in each case be a C₁-C₁₂-alkyl radical, a C₅-C₆-cycloalkyl radical and/or a C₂-C₄-hydroxyalkyl radical, which, on interaction with aqueous media, enters into a pH-dependent dissociation equilibrium and in that manner can be negatively or neutrally charged.

Suitable anionically or potentially anionically hydrophilising compounds are mono- and di-aminocarboxylic acids, mono- and di-aminosulfonic acids and also monoand di-aminophosphonic acids and their salts. Examples of such anionic or potentially anionic hydrophilising agents are N-(2-aminoethyl)-β-alanine, 2-(2-amino-ethylamino)ethanesulfonic acid, ethylenediamine-propyl- or -butylsulfonic acid, 1,2- or 1,3-propylenediamine-β-ethylsulfonic acid, glycine, alanine, taurine, lysine, 3,5-diaminobenzoic acid and the addition product of IPDA and acrylic acid (EP-A 0 916 647, Example 1). The cyclohexylaminopropanesulfonic acid (CAPS) known from WOA 01/88006 can also be used as the anionic or potentially anionic hydrophilising agent.

Preferred anionic or potentially anionic hydrophilising agents of component B2) are those of the above-mentioned type that have carboxylate or carboxylic acid groups and/or sulfonate groups, such as the salts of N-(2aminoethyl)-β-alanine, of 2-(2aminoethylamino)ethanesulfonic acid or of the addition product of IPDA and acrylic acid (EP-A 0 916 647, Example 1).

It is also possible to use for the hydrophilisation mixtures of anionic or potentially anionic hydrophilising agents and non-ionic hydrophilising agents.

In a preferred embodiment for the preparation of the special polyurethane dispersions, components A1) to A4) and B1) to B2) are used in the following amounts, the sum of the individual amounts always being 100 wt. %:

from 5 to 40 wt. % component A1),
from 55 to 90 wt. % A2),
from 0.5 to 20 wt. % in total of components A3) and B1),
from 0.1 to 25 wt. % in total of components A4) and B2), there being used from 0.1 to 5 wt. % of anionic or potentially anionic hydrophilising agents from A4) and/or B2), based on the total amount of components A1) to A4) and B1) to B2).

In a particularly preferred embodiment for the preparation of the special polyurethane dispersions, components A1) to A4) and B1) to B2) are used in the following amounts, the sum of the individual amounts always being 100 wt. %:

from 5 to 35 wt. % component A1),
from 60 to 90 wt. % A2),
from 0.5 to 15 wt. % in total of components A3) and B1),
from 0.1 to 15 wt. % in total of components A4) and B2), there being used from 0.2 to 4 wt. % of anionic or potentially anionic hydrophilising agents from A4) and/or B2), based on the total amount of components A1) to A4) and B1) to B2).

In a very particularly preferred embodiment for the preparation of the special polyurethane dispersions, components A1) to A4) and B1) to B2) are used in the following amounts, the sum of the individual amounts always being 100 wt. %:

from 10 to 30 wt. % component A1),
from 65 to 85 wt. % A2),
from 0.5 to 14 wt. % in total of components A3) and B1),
from 0.1 to 13.5 wt. % in total of components A4) and B2), there being used from 0.5 to 3.0 wt. % of anionic or potentially anionic hydrophilising agents from A4) and/or B2), based on the total amount of components A1) to A4) and B1) to B2).

The preparation of the anionically hydrophilised polyurethane dispersions (I) can be carried out in one or more step(s) in a homogeneous phase or, in the case of a multi-step reaction, partially in a disperse phase. When the polyaddition of A1) to A4) has been carried out completely or partially, a dispersing, emulsifying or dissolving step takes place. This is optionally followed by a further polyaddition or modification in the disperse phase.

It is thereby possible to use all processes known from the prior art, such as, for example, the prepolymer mixing process, the acetone process or the melt dispersion process. The acetone process is preferably used.

For preparation by the acetone process, all or some of constituents A2) to A4) and the polyisocyanate component A1) for the preparation of an isocyanate-functional polyurethane prepolymer are usually placed in a vessel and optionally diluted with a solvent that is miscible with water but inert towards isocyanate groups, and the mixture is heated to temperatures in the range from 50 to 120C. The catalysts known in polyurethane chemistry can be used to accelerate the isocyanate addition reaction.

Suitable solvents are conventional aliphatic, ketofunctional solvents such as acetone, 2-butanone, which can be added not only at the beginning of the preparation but also, optionally in portions, later in the preparation. Acetone and 2-butanone are preferred.

Other solvents such as xylene, toluene, cyclohexane, butyl acetate, methoxypropyl acetate, N-methylpyrrolidone, N-ethylpyrrolidone, solvents having ether or ester units can additionally be used and can be distilled off wholly or partially or, in the case of N-methylpyrrolidone and N-ethylpyrrolidone, can remain in the dispersion. It is preferred, however, not to use any other solvents apart from the conventional aliphatic, keto-functional solvents.

Any constituents of A1) to A4) which were not added at the beginning of the reaction are then metered in.

In the preparation of the polyurethane prepolymers from A1) to A4), the ratio of isocyanate groups to isocyanatereactive groups is from 1.05 to 3.5, preferably from 1.2 to 3.0, particularly preferably from 1.3 to 2.5.

The reaction of components A1) to A4) to form the prepolymer is carried out partially or completely, but preferably completely. In this manner, polyurethane prepolymers containing free isocyanate groups are obtained in solvent-free form or in solution.

In the neutralising step for the partial or complete conversion of potentially anionic groups into anionic groups there are used bases such as tertiary amines, for example trialkylamines having from 1 to 12 carbon atoms, preferably from 1 to 6 carbon atoms, particularly preferably from 2 to 3 carbon atoms in each alkyl radical, or alkali metal bases such as the corresponding hydroxides.

Examples thereof are trimethylamine, triethylamine, methyldiethylamine, tripropylamine, N-methylmorpholine, methyldiisopropylamine, ethyldiisopropylamine and diisopropylethylamine. The alkyl radicals can also carry hydroxyl groups, for example, as in the dialkylmonoalkanol-, alkyldialkanol- and trialkanolamines. Inorganic bases, such as aqueous ammonia solution or sodium or potassium hydroxide, can optionally also be used as neutralising agents.

Preference is given to ammonia, triethylamine, triethanolamine, dimethylethanolamine or diisopropylethylamine, as well as to sodium hydroxide and potassium hydroxide, and particular preference is given to sodium hydroxide and potassium hydroxide.

The amount of bases is from 50 to 125 mol. %, preferably from 70 to 100 mol. %, of the amount of acid groups to be neutralised. It is also possible for the neutralisation to take place at the same time as the dispersion if the dispersing water already contains the neutralising agent.

Following this, in a further process step the resulting prepolymer is dissolved with the aid of aliphatic ketones such as acetone or 2-butanone, if this has not already taken place or has taken place only partly.

In the chain extension in step B), NH₂— and/or NH-functional components are reacted partially or completely with the isocyanate groups of the prepolymer that still remain. The chain extension/termination is preferably carried out before the dispersion in water.

For the chain termination there are conventionally used amines B1) having a group reactive towards isocyanates, such as methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amideamines of diprimary amines and monocarboxylic acids, monoketimes of diprimary amines, primary/tertiary amines, such as N,N-dimethylaminopropylamine.

If anionic or potentially anionic hydrophilising agents according to definition B2) having NH₂- or NH-groups are used for the partial or complete chain extension, the chain extension of the prepolymers preferably takes place before the dispersion.

The amine components B1) and B2), optionally dissolved in water or solvent, can be used in the process according to the invention individually or in mixtures, any sequence of addition being possible in principle.

When water or organic solvents are used concomitantly as diluents, the diluent content in the component used in B) for chain extension is preferably from 70 to 95 wt. %.

The dispersion is preferably carried out following the chain extension. To this end, either the dissolved and chain-extended polyurethane polymer is introduced into the dispersing water, optionally with intensive shear, such as, for example, vigorous stirring, or, conversely, the dispersing water is stirred into the chain-extended polyurethane polymer solutions. It is preferred to add the water to the dissolved, chain-extended polyurethane polymer.

The solvent still contained in the dispersions after the dispersing step is then conventionally removed by distillation. Removal during the dispersing step is also possible.

The residual content of organic solvents in the polyurethane dispersions (I) is typically less than 1.0 wt. %, based on the total dispersion.

The pH value of the polyurethane dispersions (I) fundamental to the invention is typically less than 9.0, preferably less than 8.5, particularly preferably less than 8.0, and is very particularly preferably from 6.0 to 7.5.

The solids content of the polyurethane dispersions (I) is from 40 to 70 wt. %, preferably from 50 to 65 wt. %, particularly preferably from 55 to 65 wt. %.

The polyurethane dispersions (I) can be non-functional or functionalised via hydroxyl or amino groups. Moreover, in an embodiment that is not preferred, the dispersions (I) can also have reactive groups in the form of blocked isocyanate groups, as described, for example, in DE-A 19 856 412.

There can be used as coagulants (II) in the compositions any polyurethane polyurea dispersions containing at least 2 cationic groups. Preference is given to polyurethane polyurea dispersions whose particles are crosslinked substantially by urea groups.

The corresponding cationically hydrophilised polyurethane polyurea dispersions (II) are prepared from
C1) polyisocyanate components as described in A1), by reaction with
C2) isocyanate-reactive compounds containing cationic groups or units that can be converted into cationic groups, and optionally with
C3) non-ionically hydrophilising compounds of the components described in A4), and optionally with
C4) the polymeric polyols mentioned in A2) and/or the hydroxy-functional compounds described in A3)
   with subsequent dispersion of the resulting prepolymers in water, urea bonds forming from isocyanate groups that remain.

As hydrophilising agents C3) for the polyurethane polyurea dispersion (II) there are used isocyanatereactive compounds that contain cationic groups or units that can be converted into cationic groups. Examples of isocyanate-reactive groups are hydroxyl groups, primary or secondary amines are suitable any desired hydroxy- and/or amino-functional mono- and in particular bifunctional compounds having at least one tertiary amine nitrogen atom, at least some of whose tertiary nitrogen atoms, during or after the end of the isocyanate polyaddition reaction, can be converted into quaternary ammonium groups by neutralisation or quaternisation. They include, for example, compounds such as 2-(N,N-dimethylamino)-ethylamine, N-methyl-diethanolamine, N-methyl-diisopropanolamine, N-ethyl-diethanolamine, N-ethyl-diisopropanolamine, N,N′-bis-(2-hydroxyethyl)perhydropyrazine, N-methyl-bis(3-aminopropyl)-amine, N-methyl-bis(2-aminoethyl)-amine, N,N′,N″-trimethyl-diethylenetriamine, N,N-dimethylaminoethanol, N,N-diethylaminoethanol, 1-N,N-diethylamino-2-aminoethane, 1N,N-diethylamino-3-aminopropane, 2-dimethylaminomethyl-2methyl-1,3-propanediol, N-isopropyl-diethanolamine, N-butyl-diethanolamine, N-isobutyl-diethanolamine, N-oleyldiethanolamine, N-stearyldiethanolamine, ethoxylated coconut fatty amine, N-allyl-diethanolamine, N-methyldiisopropanolamine, N-propyl-diisopropanolamine and/or N-butyl-diisopropanolamine. It is also possible to incorporate quaternary ammonium groups and tert. amino groups next to one another or to incorporate mixtures of the mentioned amino-functional hydrophilising agents.

For the generation of the cationic hydrophilisation, the incorporation of the ionic groups, that is to say of the ternary or quaternary ammonium groups, preferably takes place with the concomitant use of structural components containing tert. amino groups, with subsequent conversion of the tert. amino groups into the corresponding ammonium groups by neutralisation with inorganic or organic acids such as, for example, hydrochloric acid, acetic acid, fumaric acid, adipic acid, maleic acid, lactic acid, tartaric acid, oxalic acid, N-methyl-N-(methylaminocarbonyl)-aminomethanesulfonic acid or phosphoric acid or by quaternisation with suitable quaternising agents such as, for example, methyl chloride, methyl iodide, dimethyl sulfate, benzyl chloride, ethyl chloroacetate or bromoacetamide. In principle, this neutralisation or quaternisation of the structural components containing tert. nitrogen can also take place before or during the isocyanate polyaddition reaction, although this is less preferred. It is also possible to introduce ternary or quaternary ammonium groups into the polyisocyanate polyaddition products via polyether polyols containing tert. amino groups, with subsequent neutralisation or quaternisation of the tert. amino groups. The incorporation of quaternary ammonium groups and of tert. amino groups next to one another or in mixtures is also possible.

The neutralisation can also be carried out at the same time as the dispersion in water, for example by dissolving the neutralising agent in water, parallel addition of the neutralising agent and of the water, or by addition of the neutralising agent after the addition of the water.

The degree of neutralisation or quaternisation is generally from 20 to 300%, preferably from 50 to 200% and particularly preferably from 70 to 130%.

The preparation of the cationically hydrophilised polyurethane polyurea dispersions (II) is carried out analogously to the principles and methods described for anionically hydrophilised polyurethane dispersions (I).

In a preferred embodiment for the preparation of the cationically hydrophilised polyurethane polyurea dispersions (II), components C1) to C4) are used in the following amounts, the sum of the individual amounts always being 100 wt. %:

from 20 to 95 wt. % component C1),
from 3 to 30 wt. % component C2),
from 0 to 50 wt. % in total of components C3),
from 0 to 50 wt. % in total of components C4).

In a particularly preferred embodiment for the preparation of the cationically hydrophilised polyurethane polyurea dispersions (II), components C1) to C4) are used in the following amounts, the sum of the individual amounts always being 100 wt. %:

from 40 to 90 wt. % component C1),
from 5 to 20 wt. % component C2),
from 0 to 30 wt. % in total of components C3),
from 0 to 30 wt. % in total of components C4).

Preferred cationically hydrophilised polyurethane polyurea dispersions (II) are prepared by using polyisocyanates A1) having a mean isocyanate functionality of greater than or equal to 3, crosslinking occurring within the dispersed particles by reaction of the water with the isocyanate groups to form urea bonds.

The cationically hydrophilised polyurethane polyurea dispersions (II) generally have a solids content of from 10 to 65 wt. %, preferably from 20 to 55 wt. %, particularly preferably from 25 to 40 wt. %.

Preferred cationically hydrophilised polyurethane polyurea dispersions (II) contain particles having a particle size of from 10 to 800 nm, preferably from 20 to 500 nm.

The amount of cationic or potentially cationic groups on the particle surface, measured by an acid-base titration, is generally from 20 to 5000 mol., preferably from 300 to 4000 mol., per gram of solids.

There are used as foam stabilisers (III) known commercially available compounds, such as, for example, water-soluble fatty acid amides, sulfosuccinamides, hydrocarbon sulfonates or soap-like compounds (fatty acid salts), for example those wherein the lipophilic radical contains from 12 to 24 carbon atoms; in particular alkanesulfonates having from 12 to 22 carbon atoms in the hydrocarbon radical, alkylbenzenesulfonates having from 14 to 24 carbon atoms in the whole of the hydrocarbon radical, or fatty acid amides or soap-like fatty acid salts of fatty acids having from 12 to 24 carbon atoms. The water-soluble fatty acid amides are preferably fatty acid amides of mono- or di-(C₂₋₃-alkanol)-amines. The soap-like fatty acid salts can be, for example, alkali metal salts, amine salts or unsubstituted ammonium salts. There come into consideration as fatty acids generally known compounds, for example lauric acid, myristic acid, palmitic acid, oleic acid, stearic acid, ricinoleic acid, behenic acid or arachidic acid, or commercial fatty acids, for example coconut fatty acid, tallow fatty acid, soya fatty acid or commercial oleic acid, as well as the hydrogenation products thereof.

The foam stabilisers (III) are advantageously those which do not decompose either under foaming conditions or under application conditions.

Preference is given to the use of a mixture of sulfosuccinamides and ammonium stearates. The mixture of sulfosuccinamides and ammonium stearates contains preferably from 20 to 60 wt. % ammonium stearates, particularly preferably from 30 to 50 wt. % ammonium stearates, and preferably from 80 to 40 wt. % sulfosuccinamides, particularly preferably from 70 to 50 wt. % sulfosuccinamides, the percentages by weight being based on the non-volatile components of both foam stabiliser classes and the sum of the wt. % being 100 wt. % in both cases.

The coating compositions according to the invention also contain crosslinkers (IV). Depending on the choice of crosslinker (IV) and of the aqueous polyurethane dispersion (I), both one-component systems and two component systems can be produced. One-component coating systems within the scope of the present invention are to be understood as being coating compositions in which the binder component (I) and the crosslinker component (IV) can be stored together without the occurrence of a crosslinking reaction to a noticeable degree or to a degree that is detrimental for the subsequent application. Two-component coating systems within the scope of the present invention are understood as being coating compositions in which the binder component (I) and the crosslinker component (IV) must be stored in separate vessels because of their high reactivity. The two components are not mixed until shortly before application, and they then generally react without additional activation. Suitable crosslinkers (IV) are,

for example, blocked or unblocked polyisocyanate crosslinkers, amide- and amine-formaldehyde resins, phenolic resins, aldehyde and ketone resins, such as, for example, phenol-formaldehyde resins, resols, furan resins, urea resins, carbamic acid ester resins, triazine resins, melamine resins, benzoguanamine resins, cyanamide resins or aniline resins. Melamine-formaldehyde resins are preferred, it being possible for up to 20 mol. % of the melamine to be replaced by equivalent amounts of urea. Methylolated melamine, for example bi-, tri- and/or tetra-methylolmelamine, is particularly preferred.

The melamine-formaldehyde resins are conventionally used in the form of their concentrated aqueous solutions, the solids content of which is from 30 to 70 wt. %, preferably from 35 to 65 wt. % and particularly preferably from 40 to 60 wt. %.

There can be used as thickeners (V) conventional thickeners, such as dextrin, starch or cellulose derivatives such as cellulose ethers or hydroxyethylcellulose, organic fully synthetic thickeners, based on polyacrylic acids, polyvinylpyrrolidones, poly(meth)acrylic compounds or polyurethanes (associative thickeners) as well as inorganic thickeners, such as bentonites or silicas.

The compositions fundamental to the invention typically contain, based on dry substance, from 80 to 99.5 parts by weight of the dispersion (I), from 0.5 to 5 parts by weight of the cationic coagulant (II), from 0.1 to 10 parts by weight of foaming aid (III), from 0 to 10 parts by weight of crosslinker (IV) and from 0 to 10 wt. % thickener (V).

The compositions fundamental to the invention preferably contain, based on dry substance, from 85 to 97 parts by weight of the dispersion (I), from 0.75 to 4 parts by weight of the cationic coagulant (II), from 0.5 to 6 parts by weight of foaming aid (III), from 0.5 to 5 parts by weight of crosslinker (IV) and from 0 to 5 wt. % thickener (V).

The compositions fundamental to the invention particularly preferably contain, based on dry substance, from 89 to 97 parts by weight of the dispersion (I), from 0.75 to 3 parts by weight of the cationic coagulant (II), from 0.5 to 5 parts by weight of foaming aid (III), from 0.75 to 4 parts by weight of crosslinker (IV) and from 0 to 4 parts by weight of thickener (V).

In addition to components (I) to (V), other aqueous binders can also be used in the compositions fundamental to the invention. Such aqueous binders can be composed, for example, of polyester, polyacrylate, polyepoxide or other polyurethane polymers. Combination with radiation curable binders, as are described, for example, in EP-A 0 753 531, is also possible. Furthermore, other anionic or non-ionic dispersions, such as polyvinyl acetate, polyethylene, polystyrene, polybutadiene, polyvinyl chloride, polyacrylate and copolymer dispersions, can also be used.

Foaming in the process according to the invention is carried out by mechanical stirring of the composition at high speeds, that is to say with the introduction of high shear forces or by expansion of a blowing gas, such as, for example, by blowing in compressed air.

Mechanical foaming can be carried out using any desired mechanical stirring, mixing and dispersing techniques. Air is generally introduced thereby, but nitrogen and other gases can also be used therefor.

The preparation of the coating compositions according to the invention from components I.) to V.) is carried out by homogeneously mixing all the components in any desired sequence by methods known in the art. Component II can also be added during or after the foaming step.

The coating compositions according to the invention can additionally also contain antioxidants and/or light stabilisers and/or other auxiliary substances and additives such as, for example, emulsifiers, antifoams, thickeners. Finally, fillers, plasticizers, pigments, silica sols, aluminium, clay, dispersions, flow agents or thixotropic agents can also be present. Depending on the desired property profile and the intended use of the coating compositions according to the invention based on PUR-dispersion, up to 70 wt. %, based on total dry substance, of such fillers can be present in the end product.

It is also possible to modify the coating compositions according to the invention by means of polyacrylates. To this end, an emulsion polymerisation of olefinically unsaturated monomers, for example esters of (meth)acrylic acid and alcohols having from 1 to 18 carbon atoms, styrene, vinyl esters or butadiene, is carried out in the presence of the polyurethane dispersion, as is described, for example, in DE-A-1 953 348, EP-A 0 167 188, EP-A 0 189 945 and EP-A 0 308 115. The monomers contain one or more olefinic double bonds. In addition, the monomers can contain functional groups such as hydroxyl, epoxy, methylol or acetoacetoxy groups.

The present invention relates also to the use of the coating compositions according to the invention in the production of microporous coatings on a wide variety of carrier materials.

Suitable carrier materials are in particular flat textile structures, flat substrates of metal, glass, ceramics, concrete, natural stone, leather, natural fibres and plastics, such as PVC, polyolefins, polyurethane or the like.

Within the scope of the present invention, flat textile structures are to be understood as being, for example, woven fabrics, knitted fabrics, bonded and non-bonded nonwovens. The flat textile structures can be composed of synthetic or natural fibres and/or mixtures thereof. In principle, textiles of any desired fibres are suitable for the process according to the invention.

The coating compositions according to the invention are stable and generally have a processing time of up to a maximum of 24 hours, depending on their composition.

Owing to their excellent extensibility and high tensile strength after film formation, the coating compositions according to the invention are suitable in particular for the production of microporous coatings on flexible substrates.

The microporous coatings are produced by first foaming the coating compositions according to the invention containing components I.) to V.).

Foaming in the process according to the invention is effected by mechanical stirring of the composition at high speeds, that is to say with the introduction of high shear forces or by expansion of a blowing gas, such as, for example, by blowing in compressed air.

Mechanical foaming can be carried out by any desired mechanical stirring, mixing and dispersing techniques. Air is generally introduced thereby, but nitrogen and other gases can also be used therefor.

The foam so obtained is applied to a substrate or introduced into a mould during foaming or immediately thereafter and is dried.

Multi-layer application with intermediate drying steps is also possible in principle. However, for more rapid drying and fixing of the foams, temperatures above 30C are preferably used. Temperatures of 200C, preferably 160C, should not be exceeded during drying, however. Drying in two or more stages, with appropriately increasing temperature gradients, is also expedient in order to prevent boiling of the coating.

Drying is generally carried out using heating and drying apparatus known per se, such as (air-circulating) drying cabinets, hot air or IR radiators. Drying by passing the coated substrate over heated surfaces, for example rollers, is also possible.

Application and drying can each be carried out discontinuously or continuously, but a fully continuous process is preferred.

Before drying, the polyurethane foams typically have foam densities of from 50 to 800 g/litre, preferably from 200 to 700 g/litre, particularly preferably from 300 to 600 g/litre (weight of all substances used [in g] based on the foamed volume of one litre).

After drying and coagulation, the polyurethane foams have a microporous, at least partially open-pore structure with cells that communicate with one another. The density of the dried foams is typically from 0.3 to 0.7 g/cm³, preferably from 0.3 to 0.6 g/cm³, and is very particularly preferably from 0.3 to 0.5 g/cm³.

The polyurethane foams have good mechanical strength and high resilience. Typically, the values for the maximum tensile strength are greater than 0.2 N/mm² and the maximum elongation is greater than 250%. Preferably, the maximum tensile strength is greater than 0.4 N/mm² and the elongation is greater than 350% (determination in accordance with DIN 53504).

After drying, the polyurethane foams typically have a thickness of from 0.1 mm to 50 mm, preferably from 0.5 mm to 20 mm, particularly preferably from 1 to 10 mm, very particularly preferably from 1 to 5 mm.

The polyurethane foams can additionally be bonded, laminated or coated with further materials, for example based on hydrogels, (semi-)permeable films, coatings or other foams.

The foamed composition is then applied to the carrier by means of conventional coating devices, for example a knife, for example a spreading knife, rollers or other foam application devices. Application can be made to one side or to both sides. The amount applied is so chosen that the increase in weight after the second drying step is from 30% to 100%, preferably from 40% to 80% and particularly preferably from 45% to 75%, relative to the textile carrier. The amount applied per m² can be influenced by the pressure in the closed knife system or by the template measurement. The wet coating weight preferably corresponds to the weight of the textile carrier. The rate of foam decomposition on the carrier is dependent on the nature and amount of the foam stabiliser (III), the coagulant (II) and the ionicity of the aqueous polyurethane dispersion (I).

Fixing of the resulting open-pore cell structure is carried out by drying at a temperature of from 35 to 100° C., preferably from 60° C. to 100° C., particularly preferably from 70° C. to 100° C. Drying can take place in a conventional drier. Drying in a microwave (HF) drier is also possible.

If necessary, the foam matrix can subsequently be fixed again in a further drying step. This optional additional fixing step is preferably carried out at from 100° C. to 175° C., particularly preferably at from 100° C. to 150° C. and very particularly preferably at from 100° C. to 139° C., the drying time being chosen so as to ensure that the PUR foam matrix is sufficiently highly crosslinked.

Alternatively, drying and fixing can be carried out in a single step following the coagulation, by direct heating to preferably from 100° C. to 175° C., particularly preferably from 100 to 150C and very particularly preferably from 100° C. to 139° C., the contact time being so chosen that adequate drying and adequate fixing of the PUR foam matrix is ensured.

The dried textile carriers can be surface-treated, for example by grinding, velourisation, roughening and/or tumbling, before, during or after the condensation. The coating compositions according to the invention can also be applied in several layers to a carrier material, for example in order to produce particularly thick foam layers.

Moreover, the microporous coatings according to the invention can also be used in multi-layer structures.

The present invention also provides substrates coated with the microporous coatings according to the invention. Owing to their excellent application-related properties, the compositions according to the invention, or the coatings produced therefrom, are suitable in particular for the coating or for the production of outer clothing, artificial leather articles, shoes, furniture coverings, interior fittings for motor vehicles, and sports equipment, this list being given solely by way of example and not to be regarded as limiting.

### EXAMPLES

Unless stated otherwise, all percentages are based on weight.

The solids contents were determined in accordance with DIN-EN ISO 3251. Unless expressly mentioned otherwise, NCO contents were determined volumetrically in accordance with DIN-EN ISO 11909.

### Substances and Abbreviations Used:

Bayhydur® VP LS 2336:hydrophilised polyisocyanate based on hexamethylene diisocyanate, solventfree, isocyanate content about 16.2%, Bayer MaterialScience AG, Leverkusen, DE
Desmodur® N 3300: polyisocyanate (trimer) based on hexamethylene diisocyanate, solventfree, viscosity about 3000 mPa s, isocyanate content about 22%, Bayer MaterialScience AG, Leverkusen, DE
Polyether LB 25: monofunctional polyether based on ethylene oxide/-propylene oxide, numberaverage molecular weight 2250 g/mol., OH number 25 mg KOHIg (Bayer MaterialScience AG, Leverkusen, DE)
Isofoams 16: antifoam, Petrofer-Chemie, Hildesheim, DE
Diaminosulfonate: NH₂—CH₂CH₂—NH—CH₂CH₂—SO₃Na (45% in water)
Desmophen® C2200: polycarbonate polyol, OH number 56 mg KOHI/g, number-average molecular weight 2000 g/mol. (Bayer MaterialScience AG, Leverkusen, DE)
PolyTHF® 2000: polytetramethylene glycol polyol, OH number 56 mg KOHIg, number-average molecular weight 2000 g/mol. (BASF AG, Ludwigshafen, DE)
Poly®THF 1000: polytetramethylene glycol polyol, OH number 112 mg KOH/g, number-average molecular weight 1000 g/mol. (BASF AG, Ludwigshafen, DE)
Stokal® STA: foaming aid based on ammonium stearate, active ingredient content: 30% (Bozzetto GmbH, Krefeld, DE)
Stokal® SR: foaming aid based on succinamate, active ingredient content: about 34% (Bozzetto GmbH, Krefeld, DE)
Praestol® 185 K: cationic flocculation aid containing structure A, solids content 25% (Degussa AG, DE)
Euderm® red: azo pigment preparation, contains C.I.Pigment red 170 (Lanxess AG, Leverkusen, DE)

The mean particle sizes (the number average is given) of the polyurethane dispersions (I) was determined by means of laser correlation spectroscopy (device: Malvem Zetasizer 1000, Malvern Inst. Limited).

### Charge Determination:

A portion of the sample is weighed to an accuracy of 0.0001 g (mass typically from 0.2 g to 1 g, depending on the charge amount); a 5 wt. % aqueous surfactant solution (Brij-96 V, Fluka, Buchs, Switzerland Product No. 16011) and double-deionised water are added thereto and, after addition of a defined amount of hydrochloric acid (0.1 n, so that the batch has a starting pH value of about pH 3; KMF Laborchemie GmbH, Lohmar, Art. No.: KMF.01-044.1000), titration is carried out with aqueous sodium hydroxide standard solution (0.05 n; Bemd Kraft GmbH, Duisburg, Art. No.: 01056.3000). In addition, in order to distinguish between the surface charge and the serum charge, a portion (about 30 g) of the dispersion is treated with ion exchanger (Lewatit® VP-OC 1293 (use of 10× the exchange capacity, based on the total charge determined, stirring time 2.0 h, Lanxess AG, Leverkusen, mixed anion/cation exchanger) and, after filtration (E-DSchnellsieb, cotton fabric 240 m, Erich Drehkopf GmbH, Ammersbek), the resulting dispersion is titrated. The surface charge is determined during titration of the sample after treatment with ion exchanger. The serum charge can be calculated by subtraction from the total charge.

Determination of the surface charge from the neutral points gives, within the accuracy of measurement, a comparable value to the determination of basic groups from the under-consumption of sodium hydroxide solution, based on the added amount of hydrochloric acid.

It follows therefrom that the charge amounts determined are basic and not weakly acidic groups (e.g. carboxyl groups). The designation eq/g stands for microequivalent per gram of solids, one equivalent being one mole of ionic groups. Positive values stand for cationic charges, negative values for anionic charges.

### Coagulant 1)

### Cationically Hydrophilised Polyurethane Polyurea Dispersion, Crosslinked by Urea Groups

In a stirred vessel, 71.32 g (0.4 gram equivalent of alcohol groups) N,N-dimethylaminoethanol are added at room temperature to 429.0 g (1.1 gram equivalents of isocyanate groups) of Desmodur® N 3300. Stirring is carried out at from 20 to 30° C. until an isocyanate content of 5.04% has been reached (titrimetric determination). 48.1 g of acetic acid are then added dropwise, and 1279 g of deionised water (about 25° C.) and 0.1 g of Isofoam® 16 are added to the resulting mixture, with vigorous stirring.

After about one hour, the resulting dispersion is evacuated to a pressure of about 200 mbar and stirred further at from 20° C. to 30° C. for about 5 hours.

The resulting white dispersion had the following properties:

| | |
|---|---|
| solids content: | 27% |
| particle size (LCS): | 84 nm |
| viscosity (viscometer, 23 C): | 100 mPas |
| pH (23° C.): | 7.25 |

Charge determination: Total charge 3078±24 μeq/g, surface charge 1379±23 μeq/g.

### Coagulant 2)

### Cationically and Non-Ionically Hydrophilised Polyurethane Polyurea Dispersion, Crosslinked by Urea Groups

In a stirred vessel, 5.91 g (0.1 gram equivalent) of 1,6-hexanediol are added at a temperature of about 50° C. to 215.5 g (1.1 gram equivalent of isocyanate groups) of Desmodur® N 3300 and stirred for about 2 hours at 80° C. until a constant isocyanate content has been achieved (titrimetric determination). 225.0 g of Polyether LB 25 are then added, and stirring is carried out for a further 3 hours at from 80° C. to 85° C. until a constant isocyanate content has been achieved. The mixture is then cooled to 30° C., and 26.7 g (0.3 gram equivalent of alcohol groups) of N,N-dimethylaminoethanol are added, followed by stirring for about 2 hours.

A solution of 18.0 g (0.3 gram equivalent) of acetic acid in 997 g of deionised water and 0.1 g of Isofoam 16 are added to the prepolymer, and the resulting dispersion is stirred vigorously for about 2 hours.

The resulting dispersion is then evacuated to a pressure of about 200 mbar and stirred further for about 5 hours at from 20 to 30C.

The resulting white dispersion had the following properties:

| | |
|---|---|
| solids content: | 32% |
| particle size (LCS): | 784 nm |
| viscosity (viscometer, 23 C): | 160 mPas |
| pH (23° C.): | 6.46 |

Charge determination: Total charge 1476+11 μeq/g, surface charge 510±2 μeq/g

### Example 1

### PUR Dispersion (Component I)

144.5 g of Desmophen® C2200, 188.3 g of PolyTHF® 2000, 71.3 g of PolyTHF® 1000 and 13.5 g of Polyether LB 25 were heated to 70° C. A mixture of 45.2 g of hexamethylene diisocyanate and 59.8 g of isophorone diisocyanate was then added at 70° C. in the course of 5 minutes, and stirring was carried out under reflux until the theoretical NCO-value had been reached. The finished prepolymer was dissolved with 1040 g of acetone at 50° C., and then a solution of 1.8 g of hydrazine hydrate, 9.18 g of diaminosulfonate and 41.9 g of water was added in metered amounts in the course of 10 minutes. The afterstirring time was 10 minutes. After addition of a solution of 21.3 g of isophoronediamine and 106.8 g of water, dispersion was carried out in the course of 10 minutes by addition of 254 g of water. The solvent was removed by distillation in vacuo.

The resulting white dispersion had the following properties:

| | |
|---|---|
| Solids content: | 60% |
| Particle size (LCS): | 285 nm |

### Example 2

### PUR Dispersion (Component I)

2159.6 g of a difunctional polyester polyol based on adipic acid, neopentyl glycol and hexanediol (mean molecular weight 1700 g/mol., OH number=66), 72.9 g of a monofunctional polyether based on ethylene oxide/propylene oxide (70/30) (mean molecular weight 2250 g/mol., OH number 25 mg KOH/g) were heated to 65° C. A mixture of 241.8 g of hexamethylene diisocyanate and 320.1 g of isophorone diisocyanate was then added at 65° C. in the course of 5 minutes, and stirring was carried out at 100° C. until the theoretical NCO-value of 4.79% had been reached. The finished prepolymer was dissolved with 4990 g of acetone at 50° C., and then a solution of 187.1 g of isophoronediamine and 322.7 g of acetone was added in metered amounts in the course of 2 minutes. The afterstirring time was 5 minutes. A solution of 63.6 g of diaminosulfonate, 6.5 g of hydrazine hydrate and 331.7 g of water was then added in metered amounts in the course of 5 minutes. Dispersion was carried out by addition of 1640.4 g of water. The solvent was removed by distillation in vacuo.

The resulting white dispersion had the following properties:

| | |
|---|---|
| Solids content: | 58.9% |
| Particle size (LCS): | 248 nm |

### Production of Foam Pastes and Microporous Coatings from the PUR Dispersions of Examples 1 to 9

The foam pastes produced were applied normally as an adhesive coat or as an intermediate coat to top coats of one-component Impraperm or Impranil brands by the transfer process.

The following devices, for example, are suitable for the production of the foam pastes from the PUR dispersions of Examples 1 to 9:

e.g.
Hansa mixer
Mondo mixer
Oakes mixer
Stork foam generator.

Application of the foam was carried out by means of roll knives. During application of the wet foam, the knife gap should be from 0.3 mm to 0.5 mm. The foam density should be from 300 to 600 g/l.

When adjusting the bonding machine, the spacing between the two rollers corresponded generally to the overall thickness of the substrate, the wet foam layer and the paper thickness.

Suitable substrates for foam coating are woven fabrics and knitted fabrics of cotton as well as nonwovens of cellulose fibres and mixtures thereof. The substrates can be used in both roughened and non-roughened form. Coating was preferably carried out on the non-roughened side. Substrates of from 140 to 200 g/m² are suitable for the production of clothing articles, and substrates of up to 240 g/m are suitable for shoe uppers.

The following coloured pastes can be used for colouring the coating pastes produced from the PUR dispersions of Examples 1 to 9:

| | | |
|---|---|---|
| e.g. | Levanox ® | brands about 10% |
| | Levanyl ® | brands about 6% |
| | Isoversal ® WL | about 10% |
| | Euderm ® brands | about 12 to 15% |
| | Eukanol ® | brands about 10% |

Preference is given to opaque colours such as Euderm® brands.

When producing the pastes, the PUR dispersions of the Examples were placed in a sufficiently large vessel with about 1% of a 25% ammonia solution.

The pH value thereby reached from 7.5 to 8.5, in order to be able to carry out a final, foam-stabilising thickening.

From 2.0 to 2.5% of the foam stabiliser Stokal® SR and up to 1.0 to 1.5% of the ammonium stearate Stokal® STA were then added with stirring by means of one of the abovementioned devices.

After a first homogenisation, pigmenting could then optionally be carried out, if desired.

When the pigments had been distributed, approximately from 1.0 to 1.5% of the melamine resin crosslinker Acrafix® ML were added.

The desired litre weight could then be set at a speed of approximately from 1500 to 2000 rpm.

With further stirring, the resulting foams were finally coagulated by addition of the cationic coagulant II); the foam volume and the viscosity remained unchanged by the coagulation. Alternatively, the addition of the cationic coagulant II) could also be carried out before the foaming step.

Thickeners were optionally added in order to adjust a viscosity of, for example, from 6000 to 8000 mPas. The amounts of thickener used were generally from 0.1 to 5%

Drying, or crosslinking, of the foam took place in a 3 zone drying channel (zone 1: 80° C., zone 2: 100° C., zone 3: 160° C.).

Pure-white or red-coloured foams having good mechanical properties and a fine microporous pore structure were obtained in all cases.

TABLE 1

| | Amount[g] | | | | | | |
|---|---|---|---|---|---|---|---|
| | Polyurethane | | | | | | |
| | dispersion | Stokal ® | Stokal ® | Acrafix ® | Coagulant | Mirox ® | Euderm ® |
| Foam No. | (Example) | STA | SR | ML | (number) | AM | red |
| 1 | 1000.0 (1) | 15 | 20 | 20 | 30 (1) | 5 | 0 |
| 2 | 1000.0 (1) | 15 | 20 | 20 | 30 (1) | 8 | 50 |
| 3 | 1000.0 (1) | 15 | 20 | 20 | 30 (2) | 5 | 0 |
| 4 | 1000.0 (1) | 15 | 20 | 20 | 30 (2) | 8 | 50 |
| 5 | 1000.0 (1) | 15 | 20 | 20 | 30 (1) | 8 | 0 |
| 6 | 1000.0 (1) | 15 | 20 | 20 | 30 (2) | 8 | 0 |
| 7 (comp.) | 1000.0 (1) | 15 | 20 | 20 | 30 | 0 | 0 |
| | | | | | (Praestol ® 185 K) | | |
| 8 (comp.) | 1000.0 (1) | 15 | 20 | 20 | 30 | 8 | 0 |
| | | | | | (Praestol ® 185 K) | | |
| 9 (comp.) | 1000.0 (1) | 15 | 20 | 20 | — | 0 | 50 |

Foams 1 to 6 all have a fine microporous structure and a high content of corresponding cells. The foam exhibits very uniform distribution of the pores.

If the coagulant is omitted (foam 9 formulation), a closed-cell, non-microporous foam is obtained.

If Praestol® 185 K is used as coagulant (foams 7 and 8), an increase in viscosity starts after mixing, which makes further processing more difficult and shortens the processing time.

In particular after addition of thickeners such as Mirox® AL (Example 8), the processability is reduced to such an extent that no more foam can be generated. Furthermore, when Praestol® 185 K is used (foam 7), the resulting microstructure of the foam is coarser.

As a result of the onset of premature coagulation, the foam is marked when Praestol® 185 K is used as coagulant (foam 7). It is therefore necessary to carry out filtration again before coating; such a step is not necessary when the cationic coagulants (II) are used (foams 1-6).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for the production of microporous coatings, in which a composition comprising an aqueous, anionically hydrophilised polyurethane dispersion (I) and a cationic coagulant (II) containing a cationically hydrophilised polyurethane polyurea dispersion is foamed and dried.

2. Process according to claim 1, wherein the process is carried out using aqueous, anionically hydrophilised polyurethane dispersions (I) that are obtained as follows:
A) isocyanate-functional prepolymers are prepared from
A1) organic polyisocyanates
A2) polymeric polyols having number-average molecular weights of from 400 to 8000 g/mol. and OH functionalities of from 1.5 to 6 and
A3) optionally hydroxy-functional compounds having molecular weights of from 62 to 400 g/mol, and
A4) optionally isocyanate-reactive, anionic or potentially anionic and optionally nonionic hydrophilising agents;
B) the free NCO groups of the prepolymers are then reacted wholly or partially
B1) with amino-functional compounds having molecular weights of from 32 to 400 g/mol. and/or
B2) with amino-functional, anionic or potentially anionic hydrophilising agents, to provide at least partial chain extension of the prepolymers;
C) the prepolymers are dispersed in water before, during or after step B), and
D) potentially ionic groups that may be present are converted into the ionic form by partial or complete reaction with a neutralising agent.

3. Process according to claim 2, wherein in the preparation of the aqueous, anionically hydrophilised polyurethane dispersions (I) in A1), 1,6-hexamethylene diisocyanate, isophorone diisocyanate, the isomers of bis-(4,4′-isocyanatocyclohexyl)methane and mixtures thereof are used, and in A2) a mixture of polycarbonate polyols and polytetramethylene glycol polyols is used, the amount of the sum of the polycarbonate and polytetramethylene glycol polyether polyols in component A2) being at least 70 wt. %.

4. Process according to claim 1, wherein auxiliary substances and additives (III) are present in addition to the polyurethane dispersion (I) and the cationic coagulant (II).

5. Process according to claim 4, wherein there are present as auxiliary substances and additives (III) water-soluble fatty acid amides, sulfosuccinamides, hydrocarbon sulfonates, sulfates or fatty acid salts as foam-forming agents and foam stabilisers.

6. Process according to claim 5, wherein mixtures of sulfosuccinamides and ammonium stearates are used as foam-forming agents and foam stabilisers, those mixtures containing from 70 to 50 wt. % sulfosuccinamides.

7. Microporous coatings obtained by a process according to claim 1.

8. Microporous coatings according to claim 7, wherein the coatings have a microporous, open-pore structure and have a density in the dried state of 0.3 to 0.7 g/cm³.

9. Compositions comprising an aqueous, anionically hydrophilised polyurethane dispersion (I) and a cationic coagulant (II) containing a cationically hydrophilised polyurethane polyurea dispersion.

10. Substrates coated with microporous coatings according to claim 8.

11. Substrates coated with microporous coatings according to claim 9.

12. Substrates according to claim 8 selected from the group consisting of outer clothing, artificial leather articles, shoes, furniture coverings, interior fittings for motor vehicles, sports equipment.
